(19) United States
(12) Patent Application Publication
(10) Pub. No.: US 2009/0323649 A1
(43) Pub. Date: Dec. 31, 2009

(54) WIRELESS MARINE COMMUNICATION SYSTEM

(76) Inventor: Ashish Kedarnath Dayama, Aurora, IL (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/164,566

(22) Filed: Jun. 30, 2008

(51) Int. Cl. H04W 4/00

(52) U.S. Cl. 370/338

(57) ABSTRACT

An exemplary device that is useful for facilitating wireless communications on a body of water includes a support platform that is configured to remain at least partially on a surface of the water. A transceiver station is mounted on the support platform. The transceiver station is configured to communicate over at least one wireless link with at least one mobile station. The transceiver station has a connection to an underwater cable through which the transceiver station communicates with another device.

### 1. FIELD OF THE INVENTION

This invention generally relates to communication. More particularly, this invention relates to wireless communications.

### 2. DESCRIPTION OF THE RELATED ART

Wireless communication systems are well known and in widespread use. Personal wireless communication devices such as cellular phones, personal digital assistants and notebook computers provide convenient communication abilities under a wide variety of circumstances. There are instances, however, in which it is not possible to establish a reliable link with a wireless communication network. One example scenario is when a mobile station is taken out to sea.

While some satellite services are available for wireless communications while on the ocean, most mobile stations communicate using cellular phone technology or wireless fidelity capabilities that are not compatible with satellite-based networks. Additionally, satellite-based systems tend to be efficient for downlink communications but not as efficient at uplink communications. Another drawback associated with using a satellite-based service is that it is generally regarded as very expensive.

### SUMMARY

An exemplary device that is useful for facilitating wireless communications on a body of water includes a support platform that is configured to remain at least partially on a surface of the water. A transceiver station is mounted on the support platform. The transceiver station is configured to communicate over at least one wireless link with at least one mobile station. The transceiver station has a connection to an underwater cable through which the transceiver station communicates with another device.

The various features and advantages of the disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system designed according to an embodiment of this invention.

FIG. 2 schematically illustrates selected portions of a wireless communication system designed according to another embodiment of this invention.

### DETAILED DESCRIPTION

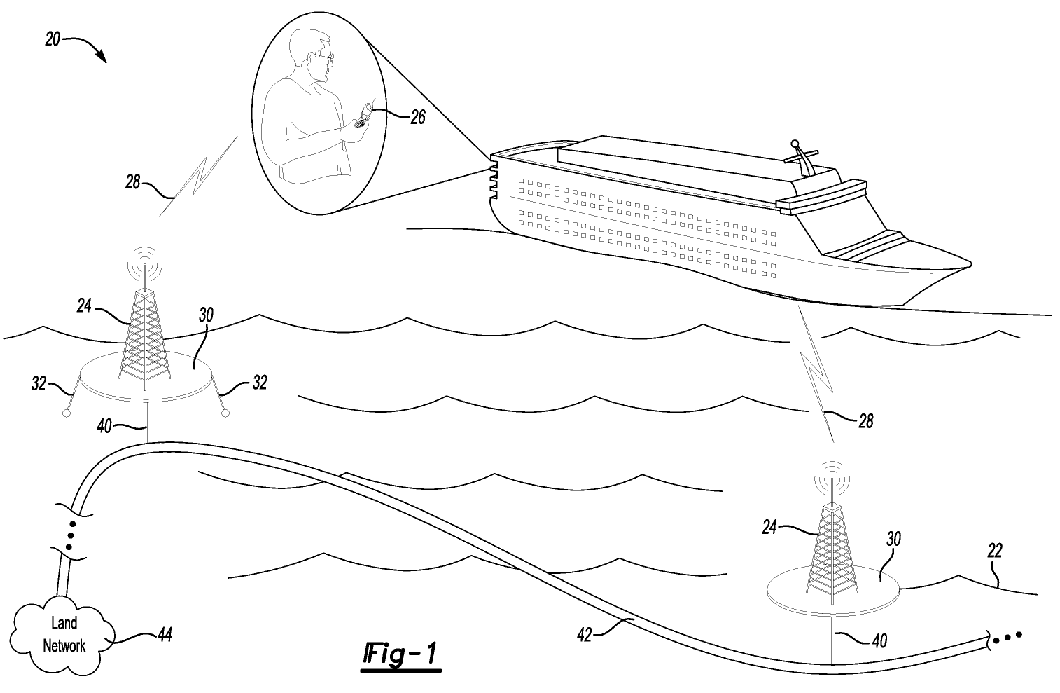

FIG. 1 schematically shows selected portions of a wireless communication system 20 that is useful for facilitating wireless communications on a body of water 22 such as an ocean. In this example, marine base station transceiver devices (MBTS) 24 are configured to communicate with at least one mobile station 26 over at least one wireless communication link 28. The MBTSs 24 provide wireless communication coverage for mobile stations that are too far out at sea, for example, to obtain a reliable signal from a land-based BTS.

The MBTSs 24 in one example communicate using cellular technology techniques such that each establishes a cell of wireless communication coverage over a surrounding area. The MBTS 24 in another example operate as wireless fidelity (e.g., Wi-Fi or WiMAX) access points and facilitate corresponding communications with the mobile station 26. Even when WiMAX technology is used an example MBTS 24 can provide wireless communication coverage over an area having a radius on the order of up to approximately 100 kilometers. Strategically placing MBTSs 24 relative to each other allows for providing at least intermittent wireless communication coverage over a vast area across a large body of water. In one example, an MBTS 24 is located at about every 750 kilometers along a chosen path across the body of water 22.

In this example, each MBTS 24 includes a support platform 30 that maintains the MBTS on or above the surface of the water 22. Some example support platforms 30 have an anchoring tether 32 that maintains a position of the corresponding MBTS 24 within a selected area.

At least some of the MBTSs 24 have a connection 40 to an underwater cable 42 that connects to a communication network 44 on land such as a public switched telephone network. The connection 40 facilitates backhaul and other communications between the MBTSs 24 and the land-based network so that wireless communications on the body of water 22 are useful for communicating with other devices or networks located on land or in remote locations on the same or another body of water, for example.

In one example, some of the connections 40 serve as an anchoring tether in addition to establishing a communication link with the cable 42.

In one example, the MBTSs are powered by batteries or a fuel cell. In another example, the MBTSs are powered by a solar power arrangement. Such powering options allow for operating the MBTSs with only a connection to the cable 42 for communication purposes as no connection to a land-based power source is needed.

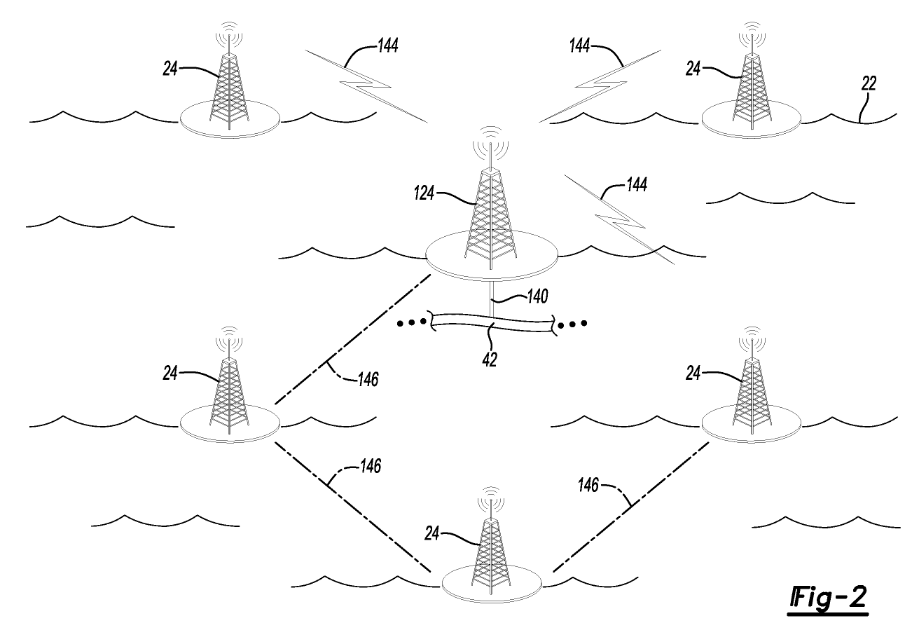

The example of FIG. 2 includes a central MBTS 124 that serves as a hub for other MBTSs 24. In this example, only the MBTS 124 has a connection 140 with the cable 42. The other MBTSs 24 communicate over wireless links 144 with the MBTS 124 or over a hardwired connection 146 between them. In this example, one of more of the MBTSs provides backhaul and access to others of the MBTSs. The illustrated cluster of MBTSs can be considered a wireless hotspot on the body of water 22. The spacing between the MBTSs in this example may be any distance that allows for effective communication between them, which will be determined based on the configuration of the MBTSs and their respective intended functions, for example.

The illustrated examples allow for providing voice, data, video, multimedia, VoIP, IPTV and other wireless communications in a marine environment at affordable rates. The illustrated examples make high speed wireless communications available to a wider variety of users and devices (e.g., any mobile station having Wi-Fi capability) over a wide area across an ocean or another large body of water.

The illustrated examples are potentially useful to shipping companies and tourists. Additionally, the disclosed examples facilitate diagnosing a problem with the underwater cable 42. For example, knowledge regarding the locations of the MBTSs can facilitate identifying a location of a cut or break in the cable 42. If one of the MBTSs is communicating with a land-based device over the cable 42 but a next MBTS is not, then the location of the cut or break can be narrowed down to the length of cable 42 between them.

Another feature of the illustrated examples is that they allow the companies that install the underwater cables 42 to capitalize on their investment by contracting with wireless service providers to earn additional income from the cable 42.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A device for facilitating wireless communications on a body of water, comprising:
a support platform configured to remain at least partially on a surface of the water;
a transceiver station mounted on the support platform, the transceiver station is configured to communicate over at least one wireless link with at least one mobile station; and
a connection to an underwater cable through which the transceiver station communicates with another device associated with a land-based communication network.

2. The device of claim 1, wherein the transceiver station communicates with the at least one wireless station using cellular communication techniques.

3. The device of claim 1, wherein the transceiver station communicates with the at least one wireless station using wireless fidelity communication techniques.

4. The device of claim 1, wherein the connection is operative to secure the support platform in a desired location area on the water.

5. The device of claim 1, comprising
an anchoring tether connected with the support platform for maintaining a position of the support platform in a desired location area on the water.

6. The device of claim 1, wherein the transceiver station is configured to communicate with other transceiver stations mounted on other support platforms such that the transceiver station provides at least a backhaul function to the other transceiver stations.

7. The device of claim 6, wherein the transceiver station is configured to communicate with the other transceiver stations over corresponding wireless links.

8. The device of claim 6, comprising hard wired connections at the transceiver station that are configured to facilitate communications with the other transceiver stations over corresponding wired connections.

9. A marine wireless communication system, comprising:
a plurality of transceiver stations positioned in selected locations on a body of water, at least some of the transceiver stations being configured to communicate over at least one wireless link with at least one mobile station, at least one of the transceiver stations having a connection to an underwater cable through which the at least one transceiver station communicates with another device associated with a land-based communication network, the at least one transceiver station communicating with at least one other of the transceiver stations such that the at least one transceiver station provides at least a backhaul function to the at least one other of the transceiver stations.

10. The system of claim 9, wherein the at least one transceiver station is configured to communicate with the at least one other transceiver station over a wireless link.

11. The system of claim 9, comprising a hard wired communication connection between the at least one transceiver station and the at least one other transceiver station.

12. The system of claim 9, wherein the at least some of the transceiver stations communicate with at least one wireless station using cellular communication techniques.

13. The system of claim 9, wherein the at least some of the transceiver stations communicate with at least one wireless station using wireless fidelity communication techniques.

14. The system of claim 9, wherein the connection of the at least one transceiver station is operative to secure the at least one transceiver station in a desired location area on the water.

15. The system of claim 9, wherein at least some of the transceiver stations comprise
a support platform; and
an anchoring tether connected with the support platform for maintaining a position of the support platform in a desired location area on the water.
